(19) United States
(12) Patent Application Publication
(10) Pub. No.: US 2010/0051056 A1
(43) Pub. Date: Mar. 4, 2010

(54) FOREIGN OBJECT REMOVAL METHOD AND METHOD FOR MANUFACTURING SEMICONDUCTOR DEVICE

(76) Inventor: Shingo KANAMITSU, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/548,011

(22) Filed: Aug. 26, 2009

(30) Foreign Application Priority Data
Aug. 28, 2008 (JP) 2008-219229

(51) Int. Cl. B08B 7/00; G06K 9/00

(52) U.S. Cl. 134/6; 382/145

(57) ABSTRACT

A tip of a carbon nanotube is lowered toward a recess where a foreign object exists to cause the tip of the carbon nanotube to contact a bottom face of the recess. Subsequently, the carbon nanotube is further lowered to cause the carbon nanotube to sag, and a side face of the carbon nanotube is pressed against the bottom face of the recess. A force is applied to the foreign object by moving the carbon nanotube on the bottom face of the recess in a state where the side face is pressed against the bottom face of the recess.

### CROSS-REFERENCE TO RELATED APPLICATIONS

This application is based upon and claims the benefits of priority from the prior Japanese Patent Application No. 2008-219229, filed on Aug. 28, 2008; the entire contents of which are incorporated herein by reference.

### BACKGROUND OF THE INVENTION

1. Field of the Invention

The present invention relates to a foreign object removal method and a method for manufacturing a semiconductor device which remove a foreign object adhered to a pattern transfer unit used to form a semiconductor integrated circuit.

2. Background Art

In the case where some kind of foreign object has undesirably entered and adhered to a recess (groove) during a manufacturing step of a photomask, etc., used for pattern transfer of a semiconductor integrated circuit, it is difficult to rinse the foreign object from the mask, even by cleaning, when the adhesive force thereof is strong. It is effective to perform cleaning after once separating the foreign object from the mask (reducing the adhesive force thereof). For example, JP-A 2006-293064 (Kokai) and JP-A 2008-102402 (Kokai) discuss using AFM (Atomic Force Microscope) technology to scratch a foreign object by applying a load to the foreign object using a probe.

In such a case, it is necessary to apply a certain amount of force to the foreign object by the probe to move the foreign object (release from the closely-adhered state), and there is a risk that a normal AFM silicon probe used for observation of a sample surface would incur damage and severe wear. Therefore, JP-A 2006-293064 (Kokai), for example, discusses scratching the foreign object using a diamond probe.

It is necessary to use a finer probe as the size of the pattern formed on the mask, that is, the groove width, is reduced. Although current probes can still be used for pattern sizes of the current 45-nm generation half pitch, finer probes fashioned from silicon and diamond will encounter limitations as future downscaling progresses.

### SUMMARY OF THE INVENTION

According to an aspect of the invention, there is provided a foreign object removal method, including: acquiring an image of a pattern transfer unit including a recession/protrusion pattern and designating a position of a foreign object adhered to a recess of the recession/protrusion pattern based on the image; relatively moving a tip of a carbon nanotube toward the recess where the foreign object exists to cause the tip of the carbon nanotube to contact a bottom face of the recess, subsequently relatively moving the carbon nanotube further to cause the carbon nanotube to sag, and pressing a side face of the carbon nanotube against the bottom face of the recess; and applying a force to the foreign object by relatively moving the carbon nanotube on the bottom face of the recess in a state where the side face is pressed against the bottom face of the recess.

According to another aspect of the invention, there is provided a method for manufacturing a semiconductor device including: causing a template for a nanoimprint in which a foreign object has been removed by the foreign object removal method mentioned above to contact a resist formed on a film to be patterned to form a resist pattern; and using the resist pattern as a mask to pattern the film to be patterned.

### BRIEF DESCRIPTION OF THE DRAWINGS

FIGS. 1A and 1B are schematic views of a template for a nanoimprint;

FIG. 2 is a schematic view illustrating a schematic configuration of a foreign object removal apparatus according to a first embodiment of the present invention;

FIG. 3 is a schematic view illustrating an example of a configuration of mounting a carbon nanotube on the same foreign object removal apparatus;

FIGS. 4A to 4C are schematic views illustrating a flow of a foreign object removal method according to the first embodiment of the present invention;

FIGS. 5A to 5D are schematic views illustrating a flow of a foreign object removal method according to the first embodiment of the present invention;

FIG. 6 is a schematic view illustrating a schematic configuration of a foreign object removal apparatus according to the first embodiment of the present invention;

FIG. 7 is a schematic view illustrating a schematic configuration of a foreign object removal apparatus according to a second embodiment of the present invention;

FIGS. 8A and 8B are schematic views illustrating a flow of a foreign object removal method according to the second embodiment of the present invention;

FIG. 9 is a schematic view illustrating a relationship between a probe and a fine pattern for an AFM apparatus of a conventional example; and

FIG. 10 is a schematic view illustrating a comparative example in which a foreign object is removed by using a carbon nanotube.

### DETAILED DESCRIPTION OF THE INVENTION

Essentially identical components in the drawings are marked with the same reference numerals.

If, for example, EUV (Extreme Ultraviolet) lithography technology becomes established for a 20 nm-generation half pitch of a line-and-space pattern, the groove width on the mask will be about 100 nm. Even if a diamond chip could be fashioned to construct a diamond probe having a tip diameter and an apical angle small enough to insert into the groove, there is a risk that the pattern portion around the foreign object would be damaged undesirably.

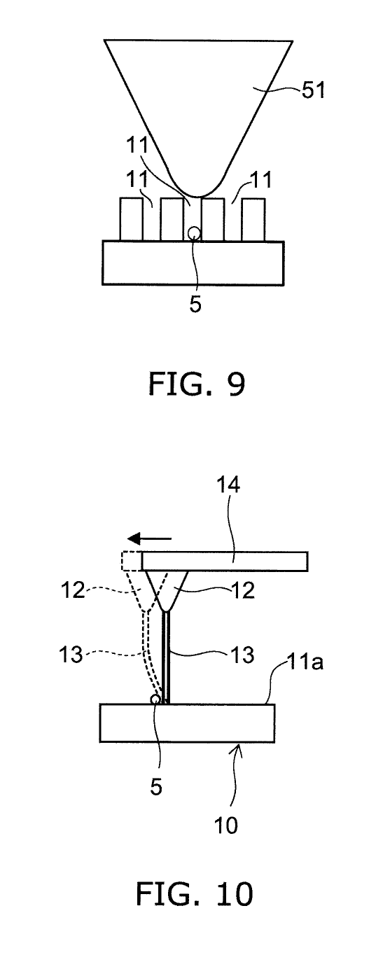

Further, in nanoimprint technology, which may become practical as the next generation of technology after EUV lithography, nanometer-level patterning is performed on a template, the template is pressed onto a resin (resist) coated on a semiconductor wafer, and the pattern is transferred onto the resin. The size ratio between the nanoimprint template and the wafer is 1:1. Therefore, the probe must, as a minimum requirement, be insertable into a groove of about 20 nm. In such a case, no matter how sharp the tip can be made, it is impossible to insert the tip of a diamond chip 51 into a groove 11 to scratch a foreign object 5 as illustrated in FIG. 9.

A carbon nanotube is an example of a fine probe for an AFM. The tip of a carbon nanotube is insertable into a groove made in a nanoimprint template having a width of 20 nm or less. However, a carbon nanotube is extremely flexible. A carbon nanotube 13 undesirably bends as illustrated by the broken lines of FIG. 10 when attempting to move the foreign object 5 by applying a force to the foreign object 5 from a horizontal direction. Therefore, sufficient force to move (separate) the foreign object 5 cannot be applied to the foreign object 5.

Due to problems such as those described above, probes can no longer provide both a fine tip and the rigidity necessary for foreign object removal as the groove width of the pattern decreases below 100 nm.

Therefore, apparatus configurations and methods of the embodiments of the present invention described below are used to remove a foreign object adhered to an ultra-fine pattern recess.

### First Embodiment

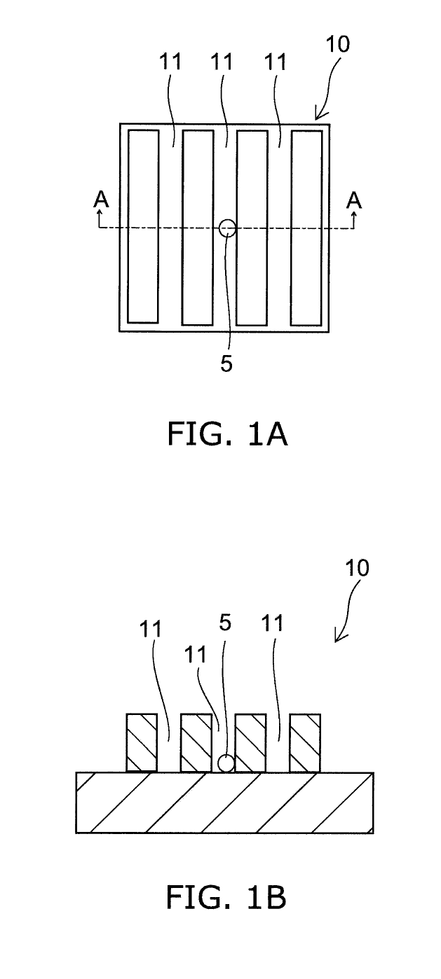

In this embodiment, a nanoimprint template 10 illustrated in FIGS. 1A and 1B is described as an example of a pattern transfer unit including a recession/protrusion pattern.

FIG. 1A is a top view of the template 10. FIG. 1B is a cross-sectional view along line A-A of FIG. 1A.

A recession/protrusion pattern corresponding to, for example, lines and spaces is formed in the template 10. For example, the groove 11, i.e., the recess, has a width (half pitch) of 20 nm, a depth of 50 nm, and an aspect ratio of 2.5.

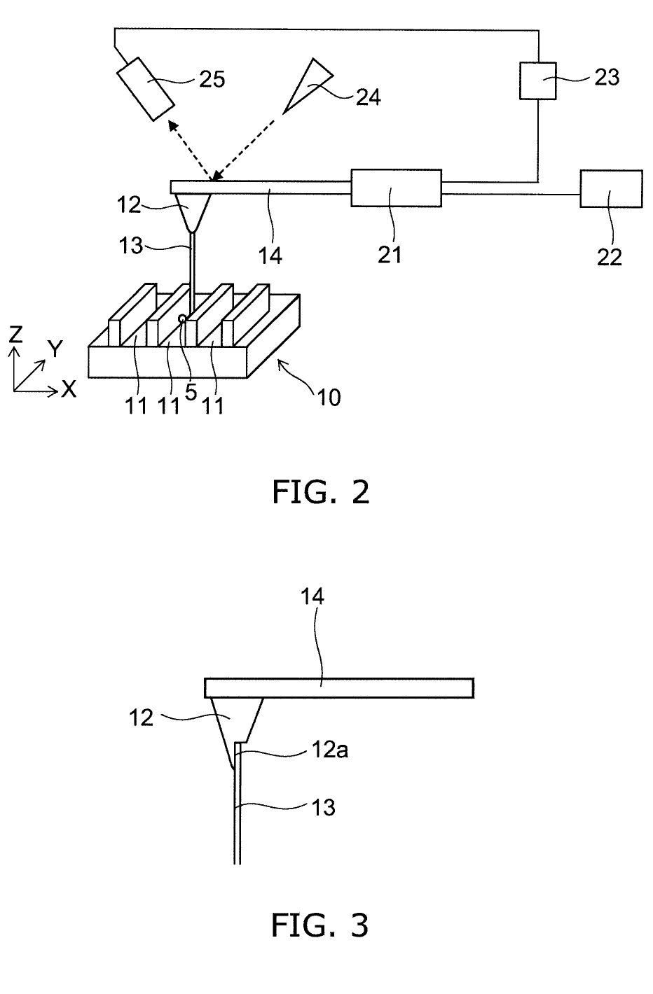

FIG. 2 is a schematic view illustrating a schematic configuration of a foreign object removal apparatus according to this embodiment.

An XYZ orthogonal coordinate system is introduced in the present specification for convenience of description hereinbelow. Referring to FIG. 1, the adjacent arrangement direction of the lines and spaces of the template 10 is assumed to be an X direction; the alignment direction (longitudinal direction) of the lines and spaces is assumed to be a Y direction; and a vertical direction orthogonal to the XY plane is assumed to be a Z direction. The template 10 is set on a not-illustrated stage capable of moving in the X, Y, and Z directions.

The foreign object removal apparatus according to this embodiment utilizes an AFM (Atomic Force Microscope) apparatus. The AFM apparatus detects a sag (a displacement in the vertical direction) of a cantilever 14 due to an atomic force or an intermolecular force acting between a probe and a sample to form an image of the sample surface configuration.

In this embodiment, the carbon nanotube 13 is used as the probe. The carbon nanotube 13 is held by one end portion of the cantilever 14 in a state where a tip of the carbon nanotube 13 is pointed downward toward the template 10 side.

An end portion on the side opposite to the tip (lower end) of the carbon nanotube 13 is mounted on, for example, a tip of a silicon base 12 fashioned in a conic configuration. As illustrated in FIG. 3, a plane 12a may be formed parallel to a vertical direction proximal to the tip of the base 12 by, for example, FIB (Focused Ion Beam) processing or the like. By mounting the carbon nanotube 13 on the plane 12a, the carbon nanotube 13 can be held in a state where the carbon nanotube 13 is aligned along the vertical direction without tilting. By using such a structure, it is easier to accurately capture the positional relationship between side walls of the groove 11 of the template 10 and the foreign object 5.

The carbon nanotube 13 has a length sufficiently longer than the depth of the groove 11 and a diameter finer than 20 nm. Currently, a single-walled type having a diameter of several nm to 10 nm and a multi-walled type having a diameter of 10 nm to 100 nm are controllable for manufacturing. An appropriate size of the carbon nanotube 13 may be selected to match the groove width into which the carbon nanotube 13 is to be inserted.

The cantilever 14 is supported at only another end portion on a side opposite to the one end portion on which the carbon nanotube 13 is provided. A triaxial fine movement mechanism 21 using, for example, a piezoelectric element is provided on the other end portion. The triaxial fine movement mechanism 21 is controlled by a controller 22. The triaxial fine movement mechanism 21 can drive the cantilever 14 and the carbon nanotube 13 held thereby in the three X, Y, and Z directions.

An optical lever measurement system detects the sag (displacement) of the cantilever 14. In other words, the amount of sag of the cantilever 14 is detected by irradiating laser light from a semiconductor laser 24 onto a back face of the cantilever 14 and using a light detector 25 (for example, a photodiode) to detect the change of the optical path of the reflected light.

The amount of sag of the cantilever 14 detected by the light detector 25 can be provided as sag signal (sag information) feedback to the triaxial fine movement mechanism 21 via a Z displacement feedback mechanism 23.

A foreign object removal method according to this embodiment using the apparatus described above will now be described.

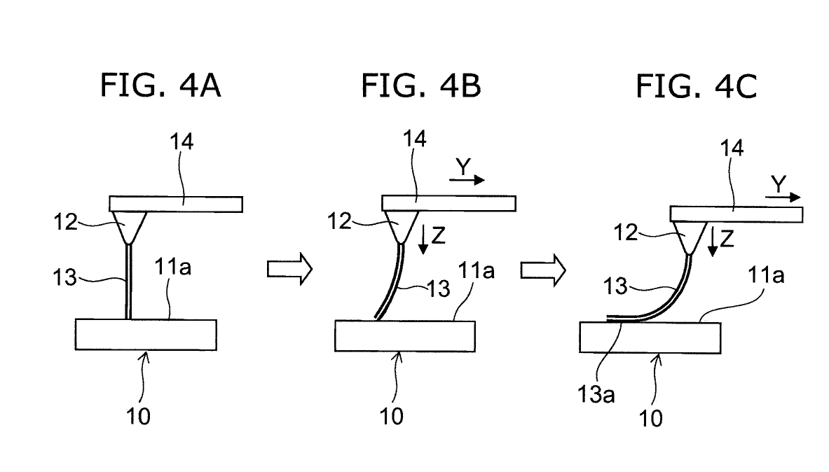

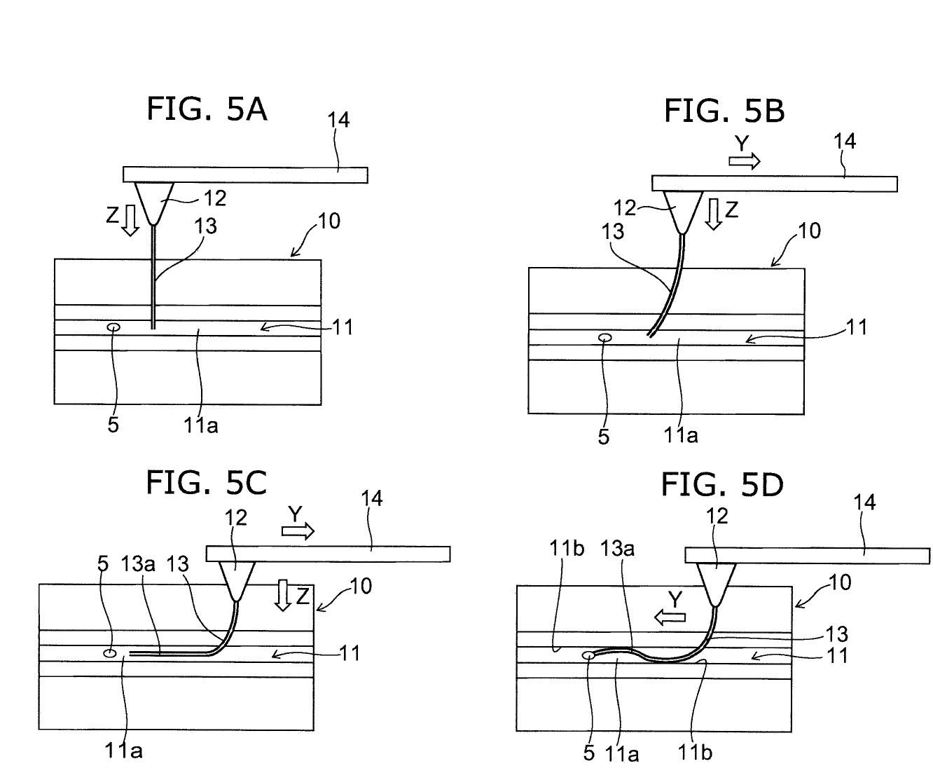

FIGS. 4A to 4C are schematic views of an operation of the cantilever 14 and the carbon nanotube 13 during foreign object removal as viewed from a side face direction of the carbon nanotube 13. FIGS. 5A to 5D are schematic views illustrating an operation similar to that of FIGS. 4A to 4C to clarify the positional relationship with the foreign object 5 in the groove 11.

The nanoimprint template 10 is set on a not-illustrated stage of the apparatus of FIG. 2. First, an image of the recession/protrusion pattern formed on the template 10 is acquired. For example, the cantilever 14 is scanned over the surface of the template 10 including the recession/protrusion pattern while performing a vertical drive control of the cantilever 14 using the optical lever measurement system described above to keep the amount of sag of the cantilever 14, that is, the Z displacement of the carbon nanotube 13, constant. An image of the surface configuration (the recession/protrusion pattern) of the template 10 is formed thereby. Based on the image, the existence or absence of the foreign object 5 is designated. In the case where the foreign object 5 exists, the position thereof is designated.

In the case where the existence and position of a foreign object 5 is designated, the carbon nanotube 13 is moved above the groove 11 where the foreign object 5 is adhered. Then, the tip of the carbon nanotube 13 is lowered in the Z direction toward a bottom face 11a of the groove 11 where the foreign object 5 exists. As illustrated in FIG. 4A and FIG. 5A, the tip of the carbon nanotube 13 is caused to contact the bottom face 11a of the groove 11.

The triaxial fine movement mechanism 21 drives the cantilever 14 to move the carbon nanotube 13 in the XY direction and the Z direction. The triaxial fine movement mechanism 21 is an actuator using, for example, a piezoelectric element or a voice coil motor capable of nanometer-order fine movement control.

It can be ascertained that the tip of the carbon nanotube 13 has reached the bottom face 11a of the groove 11 by the sag information of the cantilever 14 obtained via the light detector 25 and the Z displacement feedback mechanism 23. Also for the movement operation of the carbon nanotube 13 in the steps hereinbelow, the amount of sag of the cantilever 14 is monitored; the state or behavior of the carbon nanotube 13 is ascertained based on the sag information; and the movement operation is controlled.

After the tip of the carbon nanotube 13 is caused to contact the bottom face 11a of the groove 11, the carbon nanotube 13 is lowered further in the Z direction. Thereby, the flexible carbon nanotube 13 starts to sag in a bow-shaped configuration as illustrated in FIG. 4B and FIG. 5B.

At this time, the cantilever 14 is pressed downward in the Z direction, and the cantilever 14 simultaneously is driven in the Y direction along the groove 11. Thereby, the carbon nanotube 13 reaches a state where, for example, the carbon nanotube 13 is curved at nearly a right angle while a side face 13a of a portion of the tip side is pressed against the bottom face 11a of the groove 11 as illustrated in FIG. 4C and FIG. 5C.

FIG. 6 is a schematic view illustrating the state where the cantilever 14 is driven downward to sag and the carbon nanotube 13 is curved.

When driving the cantilever 14 in the Y direction along the groove 11, the tip of the carbon nanotube 13 can be pointed toward the foreign object 5 in a state where the carbon nanotube 13 is curved as illustrated in FIG. 5C by driving the cantilever 14 in a direction away from the foreign object 5.

The force causing the carbon nanotube 13 to flex when driving the cantilever 14 in the Z direction and the Y direction as described above must be controlled enough to avoid destruction of the junction between the carbon nanotube 13 and the base 12. Although it is possible to ascertain whether or not an appropriate force is pressing the carbon nanotube 13 against the bottom face 11a of the groove 11 from the sag information of the cantilever 14, it is also possible to press the side face 13a of the carbon nanotube 13 against the bottom face 11a of the groove 11 by setting, in advance, a distance which the carbon nanotube 13 is pressed downward and driving the cantilever 14 according to the set value instead of controlling the downward pressing force.

When the appropriate pressing force of the carbon nanotube 13 against the groove bottom face 11a is confirmed based on the sag information recited above, the downward driving of the cantilever 14 is stopped; and the cantilever 14 is driven in the Y direction along the groove 11 while maintaining the state where the side face 13a of the carbon nanotube 13 is pressed against the groove bottom face 11a, causing the carbon nanotube 13 to sag. The amount of sag of the cantilever 14 is monitored by the optical lever measurement system also during this driving. In the case where the portion of the carbon nanotube 13 pressed against the groove bottom face 11a moves in the Y direction recited above on the groove bottom face 11a and the tip of the carbon nanotube 13 or the portion of the carbon nanotube 13 pressed against the groove bottom face 11a contacts the foreign object 5, the optical lever measurement system recited above can detect a large displacement of the cantilever 14 produced by the reaction force at this time.

When such a large displacement is detected, the portion pressed against the groove bottom face 11a including the tip of the carbon nanotube 13 is moved back and forth proximal to the foreign object 5 and pressed against the foreign object 5 while driving the cantilever 14 and controlling the displacing force to avoid destruction of the junction between the carbon nanotube 13 and the base 12. A force is thereby applied to the foreign object 5.

At this time, the carbon nanotube 13 is caused to sag. Thereby, as illustrated in FIG. 5D, the carbon nanotube 13 can be moved along the groove 11 in the state where the side face 13a of the sagging carbon nanotube 13 contacts a side wall 11b of the groove 11. When the carbon nanotube 13 contacts the foreign object 5, the force pressing against the foreign object 5 can be efficiently applied to the foreign object 5 without dispersion. Thereby, even a flexible carbon nanotube 13 can apply a sufficient force to the foreign object 5, and the foreign object 5 adhered to the groove 11 can be separated.

The separation of the foreign object 5 is temporary. Although the foreign object 5 still remains in the groove 11, the foreign object 5, once separated, is then in a state of reduced adhesive force to the template 10. Therefore, the foreign object 5 can be easily removed from the template 10 by rinsing with wet cleaning in a normal mask cleaning step.

According to this embodiment, the foreign object 5 in the groove 11 can be observed and detected using the carbon nanotube 13 as a probe even for an ultra-fine pattern having a groove 11 into which a silicon or diamond probe cannot be inserted due to downscaling limitations. Although the carbon nanotube 13 could not apply a force to the foreign object 5 sufficient for separation due to the lack of rigidity of the carbon nanotube 13, the carbon nanotube 13 according to this embodiment is caused to sag and move in the groove 11 in a state where the side face 13a is pressed against the bottom face 11a of the groove 11 as described above. Thereby, sufficient pressure can be applied to the foreign object 5, and separation (movement) of the foreign object 5 is possible.

In other words, in this embodiment, even a foreign object in between an ultra-fine pattern can be separated and removed by using the fineness and flexibility of the carbon nanotube 13. In particular, this embodiment is extremely effective for foreign object removal of a nanoimprint template which is finer and has an aspect ratio larger than photomasks to date.

In this embodiment, the tip of the carbon nanotube 13 is lowered in the vertical direction and caused to contact the bottom face 11a of the groove 11, after which a control is performed to move the carbon nanotube 13 on the groove bottom face 11a in a direction away from the foreign object 5 while pressing the carbon nanotube 13 downward toward the groove bottom face 11a. Thereby, the step that causes the carbon nanotube 13 to sag and presses the side face 13a of the carbon nanotube 13 against the groove bottom face 11a can be performed extremely easily. In addition to this method, for example, it is conceivable to use a method that moves the carbon nanotube 13 proximally to the groove bottom face 11a and presses the carbon nanotube 13 against the groove bottom face 11a in a state where the carbon nanotube 13 is tilted obliquely to the groove bottom face 11a. However, in such a case, it is necessary to provide a mechanism in which the entire carbon nanotube holding mechanism is tilted or the stage holding the template is tilted, etc.

In this embodiment, the amount of sag of the cantilever 14 is monitored when moving the carbon nanotube 13. Therefore, excessive force can be avoided when causing the carbon nanotube 13 to sag and pressing the side face 13a thereof against the groove bottom face 11a or when pressing the carbon nanotube 13 against the foreign object 5. Damage of the junction between the carbon nanotube 13 and the base 12 can thereby be prevented.

The sag information of the cantilever 14 also is used to detect whether or not the foreign object 5 has separated. In addition to this method, for example, it is conceivable to use a method that confirms that the foreign object 5 has separated and moved to another position by acquiring an image of the adhesion location of the foreign object. However, in such a case, it is necessary for the carbon nanotube 13 to function as a probe for image acquisition and once again acquire an image, undesirably requiring an extremely long time. Conversely, the sag information of the cantilever 14 can be used to confirm the separation (movement) of the foreign object 5 in real time during the movement operation of the carbon nanotube 13 to reduce the time of the entire step.

### Second Embodiment

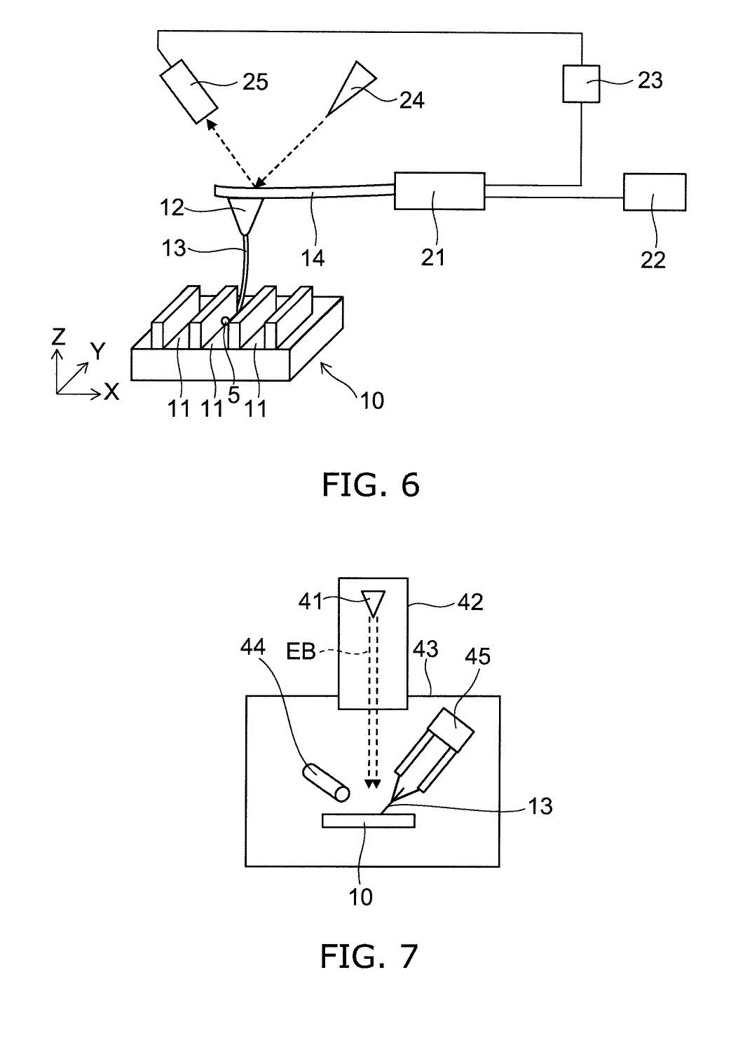

FIG. 7 is a schematic view illustrating a schematic configuration of a foreign object removal apparatus according to a second embodiment of the present invention.

In this embodiment, an apparatus combining an SEM (Scanning Electron Microscope) and an AFM (Atomic Force Microscope) is used. The movement of the carbon nanotube and the appearance of the foreign object separation are observed by the SEM.

The template 10 is set on a not-illustrated stage in a housing 43 which can be provided with a reduced-pressure atmosphere. Micro-tweezers 45 are provided in the housing 43. The micro-tweezers 45 hold the carbon nanotube 13. The micro-tweezers 45 and the carbon nanotube 13 held thereby are tilted with respect to the vertical direction and the horizontal surface (for example, tilted at about 30 degrees with respect to the horizontal surface) in a structure preventing interference with an optical column 42 of the SEM. The micro-tweezers 45 and the carbon nanotube 13 held thereby are provided in a position which also does not interfere with a secondary electron detector 44 similarly provided in the housing 43.

First, the function of the SEM is used to acquire an image of the recession/protrusion pattern formed on the template 10. In other words, an electron beam EB is irradiated from an emitter 41 toward the surface of the template 10. The image of the surface of the template 10 is obtained by using the secondary electron detector 44 to detect secondary electrons produced by the irradiation. The existence or absence of a foreign object, and further, in the case where a foreign object exists, the adhesion position thereof are designated based on the image.

In the case where the existence and position of a foreign object is designated, a tip portion of the micro-tweezers 45 holding the carbon nanotube 13 is moved proximally to the groove where the foreign object exists, and the tip of the carbon nanotube 13 is inserted into the groove where the foreign object exists.

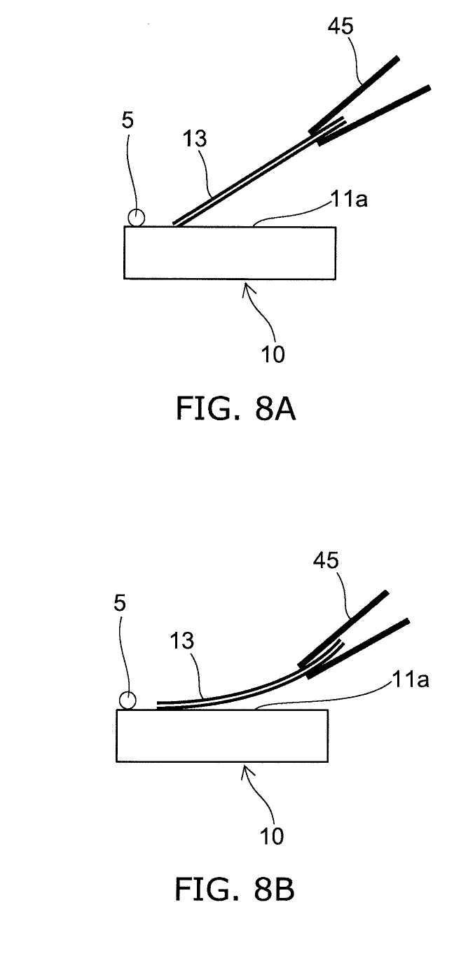

Although height information is necessary in addition to XY coordinate information in the planar direction to move the micro-tweezers 45 toward the designated groove where the foreign object exists and cause the tip of the carbon nanotube 13 to contact the groove bottom face 11, this is obtainable by possessing height information of the micro-tweezers 45 in advance and acquiring surface height information of the template 10 by a system such as a laser interferometer. Based on the height information, the micro-tweezers 45 are inserted into the groove where the foreign object exists. As illustrated in FIG. 8A, the micro-tweezers 45 are lowered toward the groove bottom face 11a until the tip of the carbon nanotube 13 contacts the groove bottom face 11a. There is a possibility that the contact between the tip of the carbon nanotube 13 and the groove bottom face 11a can be ascertained by monitoring the tunneling current, and such a method may be used.

After the tip of the carbon nanotube 13 contacts the groove bottom face 11a, the amount of movement of the micro-tweezers 45 can be controlled to cause the carbon nanotube 13 to sag as illustrated in FIG. 8B by lowering the micro-tweezers 45 further while performing image observation by the SEM. The downward movement of the micro-tweezers 45 is stopped when the carbon nanotube 13 has curved until a side face of the carbon nanotube 13 is pressed against the groove bottom face 11a.

Then, similarly to the first embodiment described above, the carbon nanotube 13 is moved along the groove in the state where the side face of the carbon nanotube 13 is pressed against the groove bottom face 11a, the carbon nanotube 13 is pressed against the foreign object 5, and a force is applied to the foreign object 5. Thereby, the foreign object 5 can be separated once from the groove. It is possible to determine in real time whether or not the foreign object 5 has separated by performing image observation by the SEM while performing this operation.

When the separation of the foreign object is confirmed, the carbon nanotube 13 is removed from the groove bottom face 11a, and the template 10 is removed from the apparatus. Then, the foreign object can be rinsed away by performing wet cleaning of the template 10. In this embodiment as well, even a foreign object in between an ultra-fine pattern can be separated and removed by using the fineness and the flexibility of the carbon nanotube 13.

Even in the case where the change of the amount of sag of the cantilever during foreign object separation is too small to be detected, confirmation of the foreign object separation can be performed reliably and in real time by SEM image observation according to this embodiment.

The pattern of a semiconductor device can be formed by implementing a nanoimprint process during the manufacture of a semiconductor device using a nanoimprint template for which the foreign objects are removed by the foreign object removal methods according to the embodiments described above.

In other words, after cleaning the template including the recess pattern, a resist pattern can be formed by causing the template to contact a resist formed on a substrate, filling the resist into the recesses of the template, then hardening the resist by light irradiation and the like, and removing the template. Then, various patterns of the semiconductor device can be formed by patterning the film to be patterned below the resist using the resist pattern as a mask. Thus, by implementing a nanoimprint process using a template for which the foreign objects are appropriately removed, it is possible to manufacture a semiconductor device having few pattern defects.

Hereinabove, embodiments of the present invention are described with reference to specific examples. However, the present invention is not limited thereto, and various modifications are possible based on the technical spirit of the present invention.

Although a nanoimprint template was described as an example of a pattern transfer unit in the embodiments described above, the present invention is not limited thereto. The present invention can be practiced similarly to perform foreign object removal also for a photomask, EUV lithography mask, etc.

Further, although a groove of a line-and-space pattern is illustrated in the embodiments described above as an example of a recess into which a foreign object has entered and from which the foreign object is to be removed, the present invention may be practiced also for a foreign object adhered in a hole. In other words, a side face of a carbon nanotube can be pressed against a bottom face and a side wall face of the hole by causing the carbon nanotube to sag (flex). Pressing the carbon nanotube against the foreign object in such a state can effectively apply a force to the foreign object without dispersion to separate the foreign object.

In regard to moving the carbon nanotube toward the recess bottom face and moving the carbon nanotube on the recess bottom face, the present invention is not limited to moving the carbon nanotube with respect to a pattern transfer unit having a fixed position. The pattern transfer unit and supporting stage thereof may be moved with respect to a fixed carbon nanotube, and, of course, both the carbon nanotube and the pattern transfer unit may be moved.

1. A foreign object removal method, comprising:
acquiring an image of a pattern transfer unit including a recession/protrusion pattern and designating a position of a foreign object adhered to a recess of the recession/protrusion pattern based on the image;
relatively moving a tip of a carbon nanotube toward the recess where the foreign object exists to cause the tip of the carbon nanotube to contact a bottom face of the recess, subsequently relatively moving the carbon nanotube further to cause the carbon nanotube to sag, and pressing a side face of the carbon nanotube against the bottom face of the recess; and
applying a force to the foreign object by relatively moving the carbon nanotube on the bottom face of the recess in a state where the side face is pressed against the bottom face of the recess.

2. The method according to claim 1, wherein a side face of the carbon nanotube is pressed against the bottom face by moving the carbon nanotube in a direction of a plane of the bottom face away from the foreign object while relatively moving the carbon nanotube in a direction perpendicular to the bottom face after causing a tip of the carbon nanotube to contact the bottom face of the recess.

3. The method according to claim 2, wherein the recession/protrusion pattern is a line-and-space pattern, and the carbon nanotube is moved in an alignment direction of the line-and-space pattern away from the foreign object.

4. The method according to claim 1, wherein the carbon nanotube is held by an end portion of a cantilever in a state where a tip of the carbon nanotube is pointed downward, and movement of the carbon nanotube is controlled while monitoring a displacement of the cantilever.

5. The method according to claim 4, wherein an image of the recession/protrusion pattern is acquired by detecting a displacement of the cantilever, the displacement being due to an atomic force or an intermolecular force acting between the carbon nanotube and the pattern transfer unit.

6. The method according to claim 4, wherein a pressing force of the carbon nanotube against the bottom face of the recess is controlled based on displacement information of the cantilever.

7. The method according to claim 1, wherein the carbon nanotube is moved on the bottom face of the recess in a state where a side face of the sagging carbon nanotube contacts a side wall of the recess.

8. The method according to claim 1, wherein an image of the recession/protrusion pattern is acquired by an electron microscope.

9. The method according to claim 8, wherein movement control of the carbon nanotube is performed while performing image observation by the electron microscope.

10. The method according to claim 1, wherein a length of the carbon nanotube is longer than a depth of the recess.

11. A method for manufacturing a semiconductor device, comprising:
acquiring an image of a template for a nanoimprint including a recession/protrusion pattern and designating a position of a foreign object adhered to a recess of the recession/protrusion pattern based on the image;
relatively moving a tip of a carbon nanotube toward the recess where the foreign object exists to cause the tip of the carbon nanotube to contact a bottom face of the recess, subsequently relatively moving the carbon nanotube further to cause the carbon nanotube to sag, and pressing a side face of the carbon nanotube against the bottom face of the recess;
applying a force to the foreign object to separate the foreign object from the bottom face by relatively moving the carbon nanotube on the bottom face of the recess in a state where the side face is pressed against the bottom face of the recess;
cleaning the template after the foreign object is separated;
causing the cleaned template to contact a resist formed on a film to be patterned to form a resist pattern; and
using the resist pattern as a mask to pattern the film to be patterned.

12. The method according to claim 11, wherein a side face of the carbon nanotube is pressed against the bottom face by moving the carbon nanotube in a direction of a plane of the bottom face away from the foreign object while relatively moving the carbon nanotube in a direction perpendicular to the bottom face after causing a tip of the carbon nanotube to contact the bottom face of the recess.

13. The method according to claim 12, wherein the recession/protrusion pattern is a line-and-space pattern, and the carbon nanotube is moved in an alignment direction of the line-and-space pattern away from the foreign object.

14. The method according to claim 11, wherein the carbon nanotube is held by an end portion of a cantilever in a state where a tip of the carbon nanotube is pointed downward, and movement of the carbon nanotube is controlled while monitoring a displacement of the cantilever.

15. The method according to claim 14, wherein an image of the recession/protrusion pattern is acquired by detecting a displacement of the cantilever, the displacement being due to an atomic force or an intermolecular force acting between the carbon nanotube and the template.

16. The method according to claim 14, wherein a pressing force of the carbon nanotube against the bottom face of the recess is controlled based on displacement information of the cantilever.

17. The method according to claim 11, wherein the carbon nanotube is moved on the bottom face of the recess in a state where a side face of the sagging carbon nanotube contacts a side wall of the recess.

18. The method according to claim 11, wherein an image of the recession/protrusion pattern is acquired by an electron microscope.

19. The method according to claim 18, wherein movement control of the carbon nanotube is performed while performing image observation by the electron microscope.

20. The method according to claim 11, wherein a length of the carbon nanotube is longer than a depth of the recess.
